(19) United States
(12) Patent Application Publication
(10) Pub. No.: US 2010/0153721 A1
(43) Pub. Date: Jun. 17, 2010

(54) Portable Electronic Devices, Systems, Methods and Computer Program Products for Accessing Remote Secure Elements

(76) Inventor: Anders Mellqvist, Malmo (SE)

Correspondence Address: MYERS BIGEL SIBLEY & SAJOVEC, P.A., P.O. BOX 37428, RALEIGH, NC, 27627, US

(21) Appl. No.: 12/487,045

(22) Filed: Jun. 18, 2009

Related U.S. Application Data
(60) Provisional application No. 61/121,943, filed on Dec. 12, 2008.

(51) Int. Cl. H04L 9/32; H04L 9/28; G06F 21/20

(52) U.S. Cl. 713/168; 726/9; 726/3

(57) ABSTRACT

Portable electronic devices are provided including a virtual secure element module configured to access a remote secure element server. The virtual secure element module being configured to access the remote secure element server from the portable electronic device to provide a predetermined level of security for secure transactions. Related systems, methods and computer program products are also provided.

### REFERENCE TO PRIORITY APPLICATION

This application claims priority to U.S. Provisional Application No. 61/121,943, filed Dec. 12, 2008, the disclosure of which is hereby incorporated herein by reference.

### FIELD OF THE INVENTION

The present invention relates to portable electronic devices, and, more particularly, to portable electronic devices configured to access secure elements.

### BACKGROUND OF THE INVENTION

Recently, many devices, for example, portable electronic devices, are configured to communicate with certain entities in a secure manner. For example, near field communication (NFC) is a standards-based (Ecma-340, ISO/IEC 18092), short-range wireless connectivity technology that may enable simple and safe two-way interactions among electronic devices, operating in the 13.56 MHz frequency range, over a typical distance of a few centimeters. NFC may use magnetic field induction to enable communication between devices when they're touched together, or brought within a few centimeters of each other. For example, NFC may be used to allow two or more portable electronic devices to exchange data. Instead of performing manual configurations, the connection between devices may be established automatically (<0.1 s). The underlying layers of NFC technology follow universally implemented ISO, ECMA and ETSI standards. Because the transmission range is so short, a degree of security can be provided by NFC-enabled transactions. Furthermore, proximity of the devices may give users the reassurance of being in control of the process. NFC can be used with a variety of devices, for example, mobile phones.

NFC-enabled transactions, such as payment and ticketing transactions, that typically require a level of security in the device. This level of security can generally only be achieved by having a separate hardware component in the device that provides a secure execution environment. This hardware component can be embedded or combined with a removable card such as a Subscriber Identity Module (SIM) card/a universal integrated circuit card (UICC) or a memory card. Hardware components by definition are physical components that cost money to produce and need to physically fit into the restricted space in the device. With the demand for smaller devices increasing inclusion of extra hardware components may not be in the best interest of the manufacturer. Furthermore, if this functionality is embedded in an existing hardware component, for example, a SIM card, distribution of new SIM cards to all customers may be difficult.

### SUMMARY OF THE INVENTION

Some embodiments of the present invention provide portable electronic devices including a virtual secure element module configured to access a remote secure element server. The virtual secure element module is configured to access the remote secure element server from the portable electronic device to provide a predetermined level of security for secure transactions.

In further embodiments of the present invention, the remote secure element server may be a networked server and the virtual secure element module may be configured to access the networked server from the portable electronic device using an encrypted communication channel to provide the predetermined level of security.

In still further embodiments, the remote secure element server may include a first remote secure element server and the virtual secure element module may be configured to access at least the first or a second remote secure element server.

In some embodiments of the present invention, the secure transactions may include a near field communication (NFC) transaction, a digital rights management transaction or a mobile television transaction.

In further embodiments of the present invention, the portable electronic device may further include at least one hardware secure element configured to provide a secure execution environment for secure transactions. The hardware secure element may be integrated with a Subscriber Identity Module (SIM) card for the portable electronic device.

In still further embodiments of the present invention, the portable electronic device may further include a soft subscriber identity module (SIM) module.

Although some embodiments of the present invention have been discussed above primarily with respect to portable electronic device embodiments, related systems, methods and computer program products are also provided.

### BRIEF DESCRIPTION OF THE DRAWINGS

FIG. 1 is a schematic block diagram illustrating a network including a portable electronic device including a virtual secure element module and a remote secure element server in accordance with some embodiments of the present invention.

FIG. 2 is a schematic block diagram illustrating a portable electronic device and a cellular communication system in accordance with some embodiments of the present invention.

FIG. 3 is a flowchart illustrating methods according to various embodiments of the present invention.

### DETAILED DESCRIPTION OF EMBODIMENTS OF THE INVENTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Example embodiments are described below with reference to block diagrams and/or flowchart illustrations of methods, devices, systems and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, example embodiments may be implemented in hardware and/or in software (including firmware, resident software, micro-code, etc.). Furthermore, example embodiments may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Java, AJAX (Asynchronous JavaScript), C, and/or C++, for development convenience. In addition, computer program code for carrying out operations of example embodiments may also be written in other programming languages, such as, but not limited to, interpreted languages. Some modules or routines may be written in assembly language or even micro-code to enhance performance and/or memory usage. However, embodiments are not limited to a particular programming language. It will be further appreciated that the functionality of any or all of the program modules may also be implemented using discrete hardware components, one or more application specific integrated circuits (ASICs), or a programmed digital signal processor or microcontroller.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

For purposes of illustration and explanation only, various embodiments of the present invention are described herein in the context of a portable electronic device, specifically a mobile terminal. It will be understood, however, that the present invention is not limited to such embodiments and may be embodied generally in any device that is capable of performing operations in accordance with some embodiments of the present invention.

As discussed above, secure transactions typically require a level of security in a device, for example, a portable electronic device, that can normally only be achieved by having a separate hardware component in the device that provides a secure execution environment. Thus, conventional methods of providing a secure execution environment typically assume that the “secure element” is somehow a physical part of the mobile phone. Conventionally, a secure element refers to a piece of hardware in the device, for example, a chip, capable of storing multiple applications. Thus, the secure element may be included in a secure memory card or an additional embedded chip in the device without departing from the scope of the present invention. With the demand for smaller devices increasing, inclusion of extra hardware components may not be in the best interest of the manufacturer.

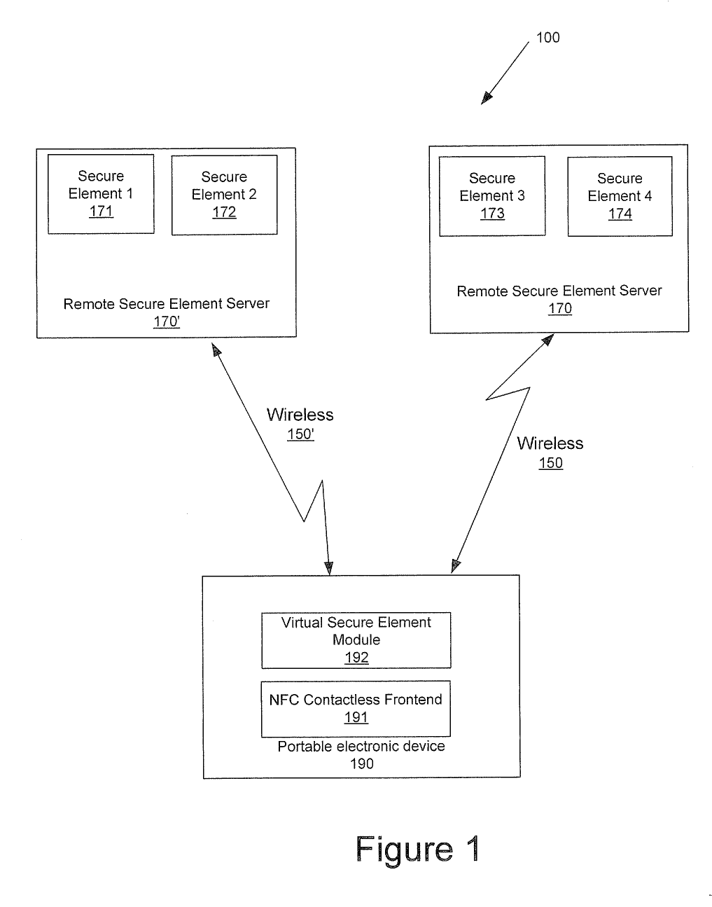

Accordingly, some embodiments of the present invention provide a secure element that is remote from the device, for example, located on a networked server. This remote secure element server may be accessed from the device, for example, the portable electronic device, using an encrypted communication channel. In some embodiments, the device includes a virtual secure element module that is configured to access the remote secure element server to establish the secure transaction. In other words, some embodiments of the present invention provide device, systems, methods and computer program products for accessing a remotely stored secure element from the device, thereby providing the security necessary for secure transactions, such as near field communication (NFC) transactions, digital rights management (DRM) schemes for music, video and mobile television without additional hardware costs in the device as will be discussed with respect to FIGS. 1 through 3 below.

Referring first to FIG. 1, a system 100 in accordance with some embodiments of the present invention may include a device, such as a portable electronic device 190, associated with one or more remote secure element servers 170, 170′. It will be understood that although embodiments of the present invention are discussed herein specifically with respect to portable electronic devices, embodiments of the present invention are not limited to this configuration. Any device capable of communicating using a secure transaction can be used without departing from the scope of the present invention. Furthermore, although embodiments of the present invention illustrated in FIG. 1 include two remote secure element servers 170, 170′ and a single portable electronic device 190, embodiments of the present invention are not limited to this configuration. Any number of these devices or additional devices may be included without departing from the scope of the present invention.

As illustrated in FIG. 1, the portable electronic device 190 in the system 100 is configured to establish a wireless connection 150, 150′ between one or more remote secure element servers 170, 170′ and the portable electronic device 190. The wireless connection 150 can be any type of wireless connection without departing from the scope of the present invention. For example, the wireless connection may be an ultra-wide band (UWB) connection, a wireless universal serial bus (USB) connection or a Wi-Fi connection.

NFC is a standards-based (Ecma-340, ISO/IEC 18092), short-range wireless connectivity technology that may enable simple and safe two-way interactions among electronic devices, operating in the 13.56 MHz frequency range, over a typical distance of a few centimeters. NFC may use magnetic field induction to enable communication between devices when they're touched together, or brought within a few centimeters of each other. For example, NFC may be used to allow two or more portable electronic devices to exchange data. Instead of performing manual configurations, the connection between devices may be established automatically (<0.1 s). The underlying layers of NFC technology follow universally implemented ISO, ECMA and ETSI standards. Because the transmission range is so short, NFC-enabled transactions provide a degree of security. Furthermore, proximity of the devices may give users the reassurance of being in control of the process. NFC can be used with a variety of devices, for example, mobile phones.

In particular, NFC may provide for contactless tickets and cards to be held in a portable electronic device. Thus, instead of carrying transport tickets, loyalty and credit cards separately, consumers can choose to store several cards in their NFC-enabled portable electronic device. Once an application, for example, a credit card, has been securely provisioned to the NFC enabled portable electronic device, customers can pay by simply waving their portable electronic device at a point-of-sale reader. For additional convenience a transaction history is easily at hand and consumers can take part in several loyalty programs without sacrificing space in their wallet.

As used herein, the term “portable electronic device” includes: a cellular radiotelephone with or without a multi-line display; a Personal Communications System (PCS) terminal that combines a cellular radiotelephone with data processing, facsimile and data communications capabilities; a Personal Data Assistant (PDA) that includes a radiotelephone, pager, Internet/intranet access, Web browser, organizer, calendar and/or a global positioning system (GPS) receiver; a gaming device, an audio video player, and a conventional laptop and/or palmtop portable computer that includes a radiotelephone transceiver. Any portable electronic device capable of operating in accordance with some embodiments of the present invention may be used without departing from the scope of the present invention.

As further illustrated in FIG. 1, the portable electronic device may include a virtual secure element module 192 and a NFC contactless frontend 191 to enable NFC communications from the portable electronic device 190. The virtual secure element module 192 is configured to communicate with one or more remote secure element servers 170, 170′. The virtual secure element module 192 is configured to access the remote secure element server 170, 170′ from the portable electronic device 190 to provide a predetermined level of security for secure transactions, for example, NFC transactions. As illustrated in FIG. 1, the remote secure element server 170, 170′ may be a networked server and the virtual secure element module 192 may be configured to access the networked server from the device using an encrypted communication channel to provide the predetermined level of security.

As further illustrated in FIG. 1, the remote secure element server 170, 170′ may include one or more secure elements 171, 172, 173 and 174. The secure element 171, 172, 173 and 174 may store such things as payment and ticketing applications such as those discussed above. Conventional secure elements are hardware elements, such as a smart card chip capable of storing multiple applications, which typically took up valuable space in the device. Accordingly, some embodiments of the present invention provide a virtual secure element module 192 in the portable electronic device that is configured to securely access a remote secure element 171, 172, 173 or 174 stored at a remote server 170,170′. Thus, the additional hardware element may be eliminated from the device, allowing the device to be made smaller. Access to more than one secure element 171, 172, 173 and 174 may also be advantageous. For example, the NFC market suffers from fragmentation when it comes to solutions for the physical location of the secure element in the device and the standard used, for example, Mifare, Felica and the like. Thus, providing more than one secure element 171, 172, 173 and 174 at the remote secure element server 170, 170′ that can be accessed by the portable electronic device 190 may enable the device 190 to work with several types of infrastructure.

As discussed above, secure transactions discussed herein are not limited to NFC transactions. For example, secure transactions may include NFC transactions, digital rights management transactions, mobile television transactions or the like without departing from the scope of the present invention.

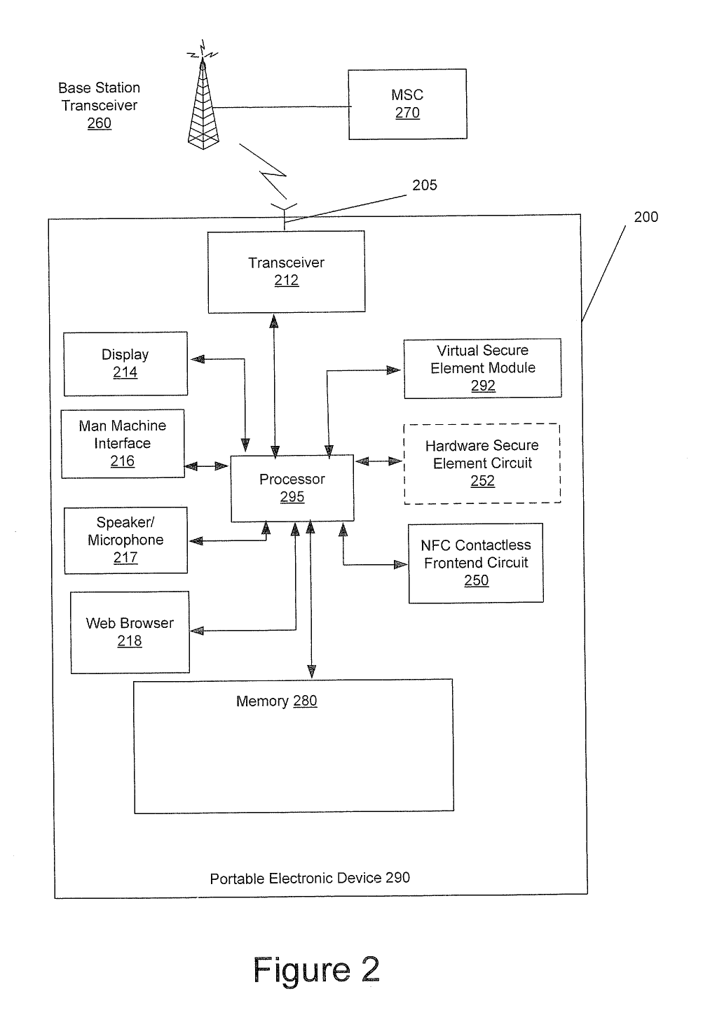

As will be further discussed with respect to FIG. 2, in some embodiments of the present invention, the portable electronic device 190 may include both a virtual secure element module 192 and at least one hardware secure element configured to provide a secure execution environment for secure transactions. In certain embodiments, the hardware secure element may be integrated with an existing hardware element in the device 190, for example, a Subscriber Identity Module (SIM) card for the portable electronic device 19.

Some embodiments of the present invention may further include a soft subscriber identity module (SIM) module in place of the hardware SIM card. These embodiments may allow further reduction in the size of the portable electronic device in compliance with current trends.

Referring now to FIG. 2, details with respect to portable electronic devices 290 in accordance with some embodiments of the present invention will be discussed. The portable electronic device 190 of FIG. 1 may include the details of the portable electronic device 290 discussed herein. As illustrated in FIG. 2, the portable electronic device 290 includes a portable housing 200 and may include a display 214, a man machine interface (MMI) 216, a speaker/microphone 217, a web browser 218, a transceiver 212 and a memory 280, any of which may communicate with a processor 295. Furthermore, portable electronic devices 290 according to embodiments of the present invention may further include a virtual secure element module 292, an NFC contactless frontend 250 to enable NFC transactions and an optional hardware secure element 252 according to some embodiments of the present invention, which also communicate with the processor 295. The dotted lines around the hardware secure element 252 indicate that this circuit is optional. It will also be understood that more than one hardware secure element 252 may be included in the portable electronic device 290. For example, the hardware secure element 252 may be a removable SD card including a secure element, an embedded secure element, a SIM card with an integrated secure element or the like without departing from the scope of the present invention. The processor 295 can be any commercially available or custom microprocessor.

As further illustrated in FIG. 2, the portable electronic device 290 communicates with a base station transceiver 260 connected to a mobile switching center (“MSC”) 270 in accordance with some embodiments of the present invention. The transceiver 212 typically includes a transmitter circuit and a receiver circuit, which respectively transmit outgoing radio frequency signals to the base station transceiver 260 and receive incoming radio frequency signals, such as voice and data signals, from the base station transceiver 260 via an antenna 205. The antenna 205 may be an embedded antenna, a retractable antenna or any antenna known to those having skill in the art without departing from the scope of the present invention. The radio frequency signals transmitted between the portable electronic device 290 and the base station transceiver 260 may include both traffic and control signals (e.g., paging signals/messages for incoming calls), which are used to establish and maintain communication with another party or destination. The processor 295 may support various functions of the portable electronic device, including a virtual secure element module 292 configured to access a remote secure element server (170, 170′ FIG. 1) to provide a predetermined level of security for secure transactions as discussed above according to some embodiments of the present invention as will be discussed further herein.

It will be understood that in some embodiments of the present invention, the transceiver 212 may be a short range transceiver. The short range transceiver may be, for example, a Bluetooth transceiver, which may allow for high transfer rates of data over relatively short distances. It will be further understood that portable electronic devices 290 according to some embodiments of the present invention may include a wireless transceiver and a short range transceiver/transmitter without departing from the scope of the present invention.

In some embodiments of the present invention, the base station transceiver 260 includes the radio transceiver(s) that defines an individual cell in a cellular network and communicates with the portable electronic device 290 and other portable electronic devices in the cell using a radio-link protocol. Although only a single base station transceiver 260 is shown, it will be understood that many base station transceivers may be connected through, for example, a mobile switching center 270 and other devices to define a wireless communications network.

Although the present invention may be embodied in communication devices or systems, such as the portable electronic device 290, the present invention is not limited to such devices and/or systems. Instead, the present invention may be embodied in any apparatus that may be configured to operate in accordance with some embodiments of the present invention.

In some embodiments, the virtual secure element module 292 is configured to access a remote secure element server 170, 170′ (FIG. 1) from the portable electronic device 290 to provide a predetermined level of security for secure transactions. The remote secure element server may be a networked server and the virtual secure element module 292 may be configured to access the networked server from the portable electronic device 290 using an encrypted communication channel to provide the predetermined level of security. As discussed above with respect to FIG. 1, there may be more than one remote secure element server and the virtual secure element module may be configured to access some or all of the remote secure element servers present. The secure transactions may be NFC transactions, digital rights management transactions or mobile television transactions without departing from the scope of the present invention.

As further illustrated in FIG. 2, the portable electronic device may further include at least one hardware secure element 252 configured to provide a secure execution environment for secure transactions. As discussed above, there may be more than one hardware secure element 252 present in the portable electronic device without departing from the scope of the present invention. For example, hardware secure element 252 may be a removable SD card including a secure element, an embedded secure element, a SIM card with an integrated secure element or the like. In some embodiments, the hardware secure element 252 may be integrated with a Subscriber Identity Module (SIM) card for the portable electronic device. Although not illustrated in FIG. 2, some embodiments of the present invention may include a soft SIM module instead or in addition to a hardware SIM card.

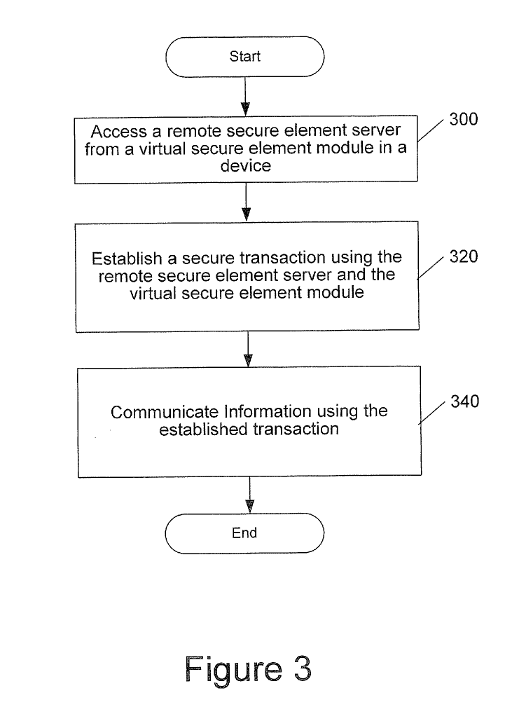

Referring now to FIG. 3, operations according to various embodiments of the present invention will be discussed. As illustrated in FIG. 3, operations for providing a secure transaction begin at block 300 by accessing a remote secure element server from a virtual secure element module positioned in a device to provide a predetermined level of security for secure transactions from the device. The remote secure element server may be a networked server and accessing may further include accessing the networked server device using an encrypted communication channel to provide the predetermined level of security. As discussed above, more than one remote secure element server may be accessible by the portable electronic device without departing from the scope of the present invention. The secure transactions may include, for example, near field communication (NFC) transactions, digital rights management transactions or mobile television transactions.

A secure transaction may be established using the virtual secure element module and the remote securing element (block 320). Information may be communicated using the established transaction (block 340). The communicated information may have the predetermined level of security.

As briefly discussed above with respect to FIGS. 1 through 3, conventional devices include a hardware secure element in the portable electronic device, which takes up valuable space in the device. Thus, according to some embodiments of the present invention, a virtual secure element module is provided in the device that is configured to access a remote secure element on a networked server using an encrypted communication channel. Thus, the hardware secure element may be eliminated from the device allowing the device to be made smaller.

Furthermore, some embodiments of the present enable fast deployment of secure NFC services with minimal hardware impact on the device. Furthermore, allowing access to more than a single secure element may enable the device to work with several types of infrastructure.

In the drawings and specification, there have been disclosed exemplary embodiments of the invention. However, many variations and modifications can be made to these embodiments without substantially departing from the principles of the present invention. Accordingly, although specific terms are used, they are used in a generic and descriptive sense only and not for purposes of limitation, the scope of the invention being defined by the following claims.

That which is claimed:

1. A portable electronic device comprising a virtual secure element module configured to access a remote secure element server, the virtual secure element module being configured to access the remote secure element server from the portable electronic device to provide a predetermined level of security for secure transactions.

2. The portable electronic device of claim 1, wherein the remote secure element server comprises a networked server and wherein the virtual secure element module is configured to access the networked server from the portable electronic device using an encrypted communication channel to provide the predetermined level of security.

3. The portable electronic device of claim 1, wherein the remote secure element server comprises a first remote secure element server and wherein the virtual secure element module is configured to access at least the first or a second remote secure element server.

4. The portable electronic device of claim 1, wherein the secure transactions comprise near field communication (NFC) transactions, digital rights management transactions and/or mobile television transactions.

5. The portable electronic device of claim 1, wherein the portable electronic device further comprises at least one hardware secure element configured to provide a secure execution environment for secure transactions, wherein the hardware secure element is integrated with a Subscriber Identity Module (SIM) card for the portable electronic device.

6. The portable electronic device of claim 1, wherein the portable electronic device further comprises a soft subscriber identity module (SIM) module.

7. A system for providing secure transactions, the system comprising:
a device including a virtual secure element module; and
a remote secure element server configured to communicate with the virtual secure element module of the device, the virtual secure element module being configured to access the remote secure element server from the device to provide a predetermined level of security for secure transactions.

8. The system of claim 7, wherein the remote secure element server comprises a networked server and wherein the virtual secure element module is configured to access the networked server from the device using an encrypted communication channel to provide the predetermined level of security.

9. The system of claim 8, wherein the remote secure element server comprises a first remote secure element server and wherein the virtual secure element module is configured to access at least the first or a second remote secure element server.

10. The system of claim 8, wherein the secure transactions comprise near field communication (NFC) transactions, digital rights management transactions and/or mobile television transactions.

11. The system of claim 8, wherein the device comprises a portable electronic device, the system further comprising:
at least one hardware secure element configured to provide a secure execution environment for secure transactions, wherein the hardware secure element is integrated with a Subscriber Identity Module (SIM) card for the portable electronic device.

12. The system of claim 8, wherein the device comprises a portable electronic device and wherein the portable electronic device comprises a soft subscriber identity module (SIM) module.

13. A computer implemented method for providing a secure transaction comprising accessing a remote secure element server from a virtual secure element module positioned in a device to provide a predetermined level of security for secure transactions from the device.

14. The method of claim 13, wherein the remote secure element server comprises a networked server and wherein accessing further comprises accessing the networked server device using an encrypted communication channel to provide the predetermined level of security.

15. The method of claim 13, wherein the remote secure element server comprises a first remote secure element server and wherein accessing further comprises accessing at least the first or a second remote secure element server from the virtual secure element module.

16. The method of claim 13, wherein the secure transactions comprise near field communication (NFC) transactions, digital rights management transactions and/or mobile television transactions.

17. The method of claim 13, further comprising establishing the secure transaction using the virtual secure element module and the remote secure element.

18. The method of claim 17, further comprising communicating information using the established transaction, the communicated information having the predetermined level of security.

19. The method of claim 13 implemented by a computer program product comprising a computer-readable storage medium having computer-readable program code embodied in said medium.
